(19) United States
(12) Patent Application Publication
(10) Pub. No.: US 2017/0199816 A1
(43) Pub. Date: Jul. 13, 2017

(54) INFORMATION PROCESSING DEVICE, DATA STORAGE METHOD, AND RECORDING MEDIUM

(71) Applicant: NEC Corporation, Minato-ku, Tokyo (JP)

(72) Inventor: Takamichi Miyamoto, Tokyo (JP)

(73) Assignee: NEC Corporation, Minato-ku, Tokyo (JP)

(21) Appl. No.: 15/315,457

(22) PCT Filed: Jun. 17, 2015
(86) PCT No.: PCT/JP2015/003032

§ 371 Date: Dec. 1, 2016

(30) Foreign Application Priority Data
Jun. 19, 2014 (JP) 2014-125865

(51) Int. Cl. G06F 12/0802; G06N 7/00

(52) U.S. Cl. CPC G06F 12/0802; G06N 7/005; G06F 17/16

(57) ABSTRACT

A pattern matching process between data sets each including a plurality of types of data elements is executed at high speed. A data storage device (200) places a predetermined number of data sets on a memory of a computer. The data set includes a plurality of types of data elements. In the computer, a program for repeatedly carrying out a set of processes for the predetermined number of the data sets is executed. The set of processes includes carrying out a predetermined operation sequentially for respective types of data elements in the data set when a predetermined condition is satisfied. In the data storage device (200), a placement decision unit (213) decides placement order on the memory in such a way that, for data elements of a specific type among data elements of the plurality of types, data elements of different data sets are placed sequentially in order in which the data elements are processed by the program, for data elements of a type other than the specific type, data elements of a same data set are placed sequentially in order in which the data elements are processed by the program. The data placement unit (214) places the predetermined number of the data sets in accordance with the placement order.

### TECHNICAL FIELD

The present invention relates to an information processing device, a data storage method, and a recording medium.

### BACKGROUND ART

A pattern matching process is a process of comparing a comparison-source data set with each of a plurality of comparison-destination data sets to extract a comparison-destination data set that matches with the comparison-source data set. The comparison-source data set and the comparison-destination data sets are constituted of a plurality of types of data elements.

Such a pattern matching process includes: a plurality of non-matching determinations, in which non-matching between a comparison-source data set and a comparison-destination data set is determined; and a matching determination, in which matching between a comparison-source data set and a comparison-destination data set is determined.

A plurality of non-matching determinations respectively correspond to a plurality of types and are executed in sequence. In each of the non-matching determinations, determination is made as to data elements of a type that corresponds to the non-matching determination. When non-matching is determined as a result of non-matching determinations down to a certain type, non-matching determinations of subsequent types and a matching determination are not carried out.

In addition, in a matching determination, determination is made by using all types of data elements included in data sets.

A pattern matching process between a comparison-source data set and a plurality of comparison-destination data sets is carried out by repeating a pattern matching process (a loop process) for each of the comparison-destination data sets. In each loop process, a plurality of non-matching determinations and a matching determination are carried out for the comparison-destination data set.

On the other hand, when a pattern matching process is executed by a program on a computer, a processor including a memory hierarchical structure such as a cache memory and a vector arithmetic unit is used.

In order to accelerate a pattern matching process by such a processor, it is important to shorten execution time relating to loading of a data set.

For example, PTL 1 discloses such a technique for shortening execution time relating to loading of a data set. In the technique described in PTL 1, a plurality of arrays to be accessed in sequence in a loop are grouped into a group, and each of data elements is placed on a memory in such a way that data elements of different arrays belonging to a group are sequentially placed.

Note that PTL 2 discloses, as a related art, a technique of improving a cache hit rate by replacing one array with another array between any two arrays described in a loop of a program. In addition, PTL 3 discloses a technique of effectively using a cache by allocating, based on dependency relation between loops of a program, a storage destination of a data element processed in a loop to either a memory or the cache.

### CITATION LIST

### Patent Literature

[PTL 1] Japanese Patent Application Laid-Open Publication No. 2004-021425

[PTL 2] Japanese Patent Application Laid-Open Publication No. 2003-228488

[PTL 3] Japanese Patent Application Laid-Open Publication No. 2010-244204

### SUMMARY OF INVENTION

### Technical Problem

When the above-described technique in PTL 1 is applied to a pattern matching process including non-matching determinations, it is conceivable that respective types of data elements in the same data set which may be possibly accessed in sequence in a loop process are grouped and placed sequentially on a memory. As described above, however, in the pattern matching process, when non-matching is determined as a result of non-matching determinations down to a certain type, non-matching determinations of subsequent types are not carried out. Consequently, even when data elements in the same data set are placed sequentially on a memory, the data elements may not always be accessed in sequence, resulting in ineffective use of a cache memory.

An object of the present invention is to provide an information processing device, a data storage method, and a recording medium that solve the above-described problem and execute a pattern matching process between data sets each including a plurality of types of data elements at high speed.

### Solution to Problem

An information processing device according to an exemplary aspect of the invention, that is for placing a predetermined number of data sets each including a plurality of types of data elements on a memory of a computer in which a program for repeatedly carrying out a set of processes for the predetermined number of the data sets is executed, the set of processes including carrying out a predetermined operation sequentially for respective types of data elements in the data set when a predetermined condition is satisfied, includes: a placement decision means for deciding placement order on the memory in such a way that, for data elements of a specific type among data elements of the plurality of types, data elements of different data sets are placed sequentially in order in which the data elements are processed by the program and, for data elements of a type other than the specific type, data elements of a same data set are placed sequentially in order in which the data elements are processed by the program; and a data placement means for placing the predetermined number of the data sets on the memory of the computer in accordance with the placement order.

An data storage method according to an exemplary aspect of the invention, that is for placing a predetermined number of data sets each including a plurality of types of data elements on a memory of a computer in which a program for repeatedly carrying out a set of processes for the predetermined number of the data sets is executed, the set of processes including carrying out a predetermined operation sequentially for respective types of data elements in the data set when a predetermined condition is satisfied, includes: deciding placement order on the memory in such a way that, for data elements of a specific type among data elements of the plurality of types, data elements of different data sets are placed sequentially in order in which the data elements are processed by the program and, for data elements of a type other than the specific type, data elements of a same data set are placed sequentially in order in which the data elements are processed by the program; and placing the predetermined number of the data sets on the memory of the computer in accordance with the placement order.

A computer readable storage medium according to an exemplary aspect of the invention records thereon a program for an information processing device for placing a predetermined number of data sets each including a plurality of types of data elements on a memory of a computer in which a program for repeatedly carrying out a set of processes for the predetermined number of the data sets is executed, the set of processes including carrying out a predetermined operation sequentially for respective types of data elements in the data set when a predetermined condition is satisfied, causing the information processing device to perform a method including: deciding placement order on the memory in such a way that, for data elements of a specific type among data elements of the plurality of types, data elements of different data sets are placed sequentially in order in which the data elements are processed by the program and, for data elements of a type other than the specific type, data elements of a same data set are placed sequentially in order in which the data elements are processed by the program; and placing the predetermined number of the data sets on the memory of the computer in accordance with the placement order.

### Advantageous Effects of Invention

An advantageous effect of the present invention is to enable to execute a pattern matching process between data sets each including a plurality of types of data elements at high speed.

### BRIEF DESCRIPTION OF DRAWINGS

FIG. 1 is a block diagram illustrating a characteristic configuration according to a first exemplary embodiment of the present invention.

FIG. 2 is a block diagram illustrating a configuration of a pattern matching system according to the first exemplary embodiment of the present invention.

FIG. 3 is a block diagram illustrating a configuration of a data storage device 200 implemented by a computer according to the first exemplary embodiment of the present invention.

FIG. 4 is a diagram illustrating an example of data sets to be used in a pattern matching process according to the first exemplary embodiment of the present invention.

FIG. 5 is a diagram illustrating a configuration of a matching program 900 according to the first exemplary embodiment of the present invention.

FIG. 6 is a diagram illustrating data elements to be accessed by respective non-matching determination processes 930-j according to the first exemplary embodiment of the present invention.

FIG. 7 is a flowchart illustrating processing of the matching program 900 according to the first exemplary embodiment of the present invention.

FIG. 8 is a flowchart illustrating processing of data storage according to the first exemplary embodiment of the present invention.

FIG. 9 is a diagram illustrating placement order of data elements on a memory 103 according to the first exemplary embodiment of the present invention.

FIG. 10 is a block diagram illustrating a configuration of a pattern matching system according to a second exemplary embodiment of the present invention.

FIG. 11 is a flowchart illustrating processing of data storage according to the second exemplary embodiment of the present invention.

FIG. 12 is a diagram illustrating an example of a program code of the matching program 900 according to the second exemplary embodiment of the present invention.

FIG. 13 is a diagram illustrating an example of a program code of the converted matching program 900 according to the second exemplary embodiment of the present invention.

FIG. 14 is a diagram illustrating an example of conversion of the matching program 900 according to the second exemplary embodiment of the present invention.

FIG. 15 is a diagram illustrating another example of a program code of the converted matching program 900 according to the second exemplary embodiment of the present invention.

FIG. 16 is a block diagram illustrating a configuration of a pattern matching system according to a third exemplary embodiment of the present invention.

FIG. 17 is a flowchart illustrating processing of data storage according to the third exemplary embodiment of the present invention.

FIG. 18 is a diagram illustrating an example of priority levels for the non-matching determination processes 930-j according to the third exemplary embodiment of the present invention.

FIG. 19 is a diagram illustrating an example of rearrangement of the non-matching determination processes 930-j according to the third exemplary embodiment of the present invention.

FIG. 20 is a diagram illustrating placement order of data elements on the memory 103 according to the third exemplary embodiment of the present invention.

FIG. 21 is a block diagram illustrating a configuration of a pattern matching system according to a fourth exemplary embodiment of the present invention.

FIG. 22 is a flowchart illustrating processing of data storage according to the fourth exemplary embodiment of the present invention.

FIG. 23 is a diagram illustrating an example of loop splitting according to the fourth exemplary embodiment of the present invention.

FIG. 24 is a diagram illustrating an example of a program code of the converted matching program 900 according to the fourth exemplary embodiment of the present invention.

FIG. 25 is a diagram illustrating another example of a program code of the converted matching program 900 according to the fourth exemplary embodiment of the present invention.

FIG. 26 is a diagram illustrating another example of a program code of the converted matching program 900 according to the fourth exemplary embodiment of the present invention.

FIG. 27 is a diagram illustrating an example of loop splitting according to a fifth exemplary embodiment of the present invention.

FIG. 28 is a block diagram illustrating a configuration of a pattern matching system according to a sixth exemplary embodiment of the present invention.

FIG. 29 is a flowchart illustrating processing of data storage according to the sixth exemplary embodiment of the present invention.

### DESCRIPTION OF EMBODIMENTS

### First Exemplary Embodiment

A first exemplary embodiment of the present invention is described.

First, a pattern matching process according to the first exemplary embodiment of the present invention is described.

FIG. 4 is a diagram illustrating an example of data sets to be used in the pattern matching process according to the first exemplary embodiment of the present invention.

As illustrated in FIG. 4, one comparison-source data set 801 “S” and M (where M is an integer equal to or more than 1) comparison-destination data sets 802 “Fi (where i is an integer of 1 to M)” are used in the pattern matching process. The comparison-source data set 801 and the comparison-destination data sets 802 are respectively constituted of N (where N is an integer equal to or more than 1) types of data elements “dj (where j is an integer of 1 to N)”. Hereinafter, the j-th data element in the comparison-source data set 801 is referred to as “S-dj”. In addition, the j-th data element in the i-th comparison-destination data set 802 is referred to as “Fi-dj”.

Next, the pattern matching process according to the first exemplary embodiment of the present invention is described.

In the first exemplary embodiment of the present invention, the pattern matching process is carried out by executing a pattern matching program (matching program 900) on a computer.

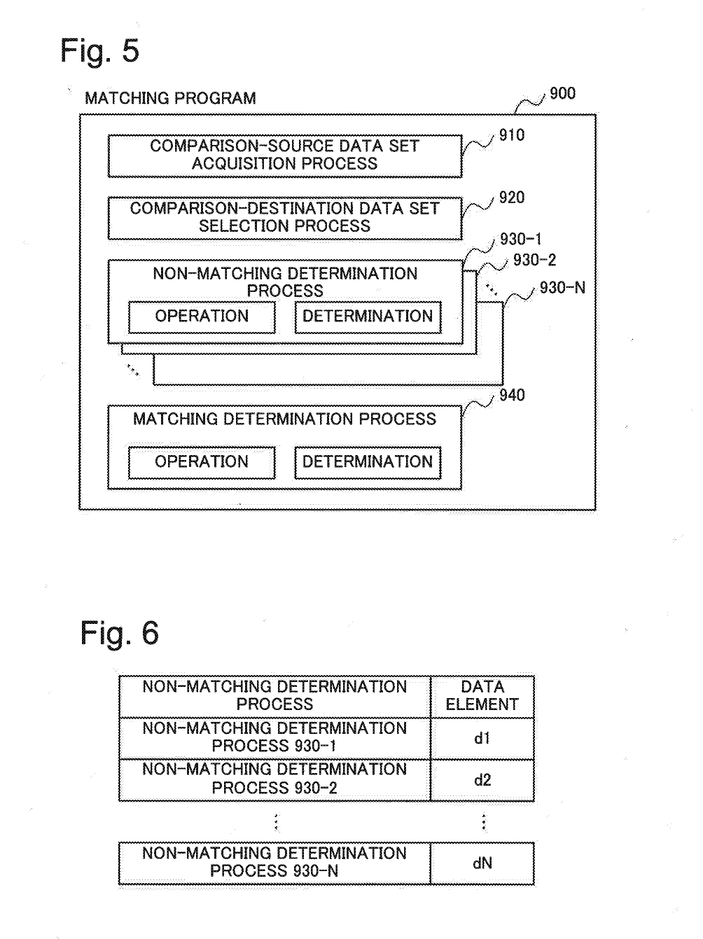

FIG. 5 is a diagram illustrating a configuration of the matching program 900 according to the first exemplary embodiment of the present invention.

The matching program 900 includes a comparison-source data set acquisition process 910, a comparison-destination data set selection process 920, N non-matching determination processes 930-j (where j is an integer of 1 to N), and a matching determination process 940.

The comparison-source data set acquisition process 910 acquires a comparison-source data set 801 stored in a memory. The comparison-destination data set selection process 920 selects a comparison-destination data set 802 for performing pattern matching with the comparison-source data set 801. The non-matching determination process 930-j carries out a non-matching determination for data elements “dj” between the comparison-source data set 801 and the comparison-destination data set 802. The matching determination process 940 carries out a matching determination between the comparison-source data set 801 and the comparison-destination data set 802.

FIG. 6 is a diagram illustrating data elements to be accessed by the respective non-matching determination processes 930-j according to the first exemplary embodiment of the present invention.

As illustrated in FIG. 6, the non-matching determination process 930-j accesses data element “dj” (“S-dj” and “Fi-dj”) stored in a memory 103.

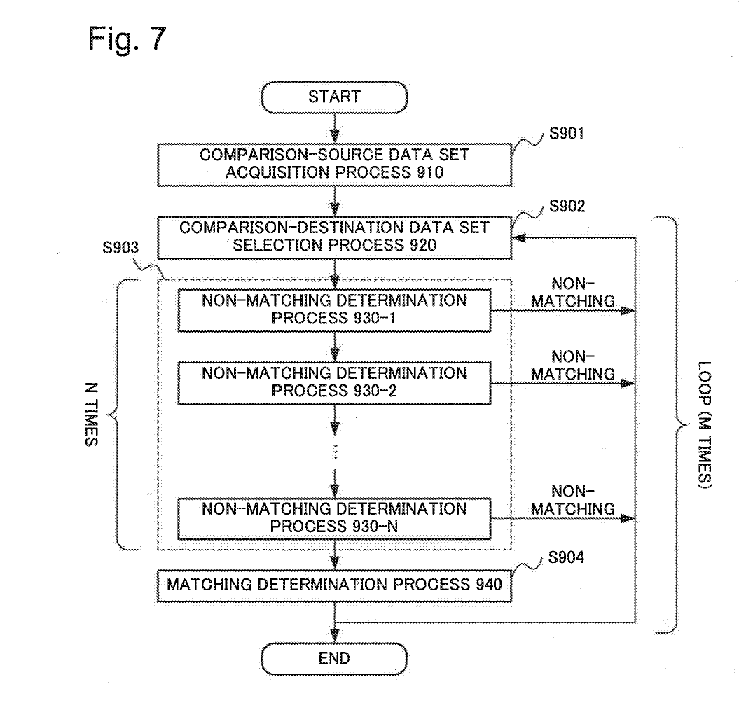

FIG. 7 is a flowchart illustrating processing of the matching program 900 according to the first exemplary embodiment of the present invention.

The comparison-source data set acquisition process 910 acquires a comparison-source data set 801 (Step S901).

The comparison-destination data set selection process 920 selects one comparison-destination data set 802 to be processed from among comparison-destination data sets 802 (Step S902).

The non-matching determination process 930-j carries out a non-matching determination (predetermined operation) for data elements dj in data sets between the comparison-source data set 801 and the comparison-destination data set 802 (Step S903). Non-matching determinations by the respective non-matching determination processes 930-j are carried out in order in accordance with the matching program 900. In the example in FIG. 7, non-matching determinations are carried out in order of the non-matching determination processes 930-1, 930-2, . . . , 930-N.

Each of the non-matching determination processes 930-j calculates, for example, an absolute value of a difference in the data elements dj between the comparison-source data set 801 and the comparison-destination data set 802. When the absolute value of the difference is equal to or more than a predetermined threshold value, for example, the non-matching determination process 930-j then makes determination of non-matching.

When non-matching is determined in each of the non-matching determination processes 930-j, the processing returns to Step S902. When non-matching is not determined in each of the non-matching determination process 930-j (when a predetermined condition is satisfied), a next non-matching determination process 930-j carries out a non-matching determination in accordance with the matching program 900.

When non-matching is not determined in the N non-matching determination processes 930-j, the matching determination process 940 carries out a matching determination between the comparison-source data set 801 and the comparison-destination data set 802 (Step S904).

The matching determination process 940 carries out a predetermined operation between the comparison-source data set 801 and the comparison-destination data set 802, such as adding up values obtained by multiplying respective absolute values of differences in data elements by a predetermined coefficient. When a value obtained as a result of the operation is less than a predetermined threshold value, for example, the matching determination process 940 then makes determination of matching.

The processing from the comparison-destination data set selection process 920 to the matching determination process 940 forms a loop. The loop is repeated by the number of the comparison-destination data sets 802.

Next, a configuration according to the first exemplary embodiment of the present invention is described.

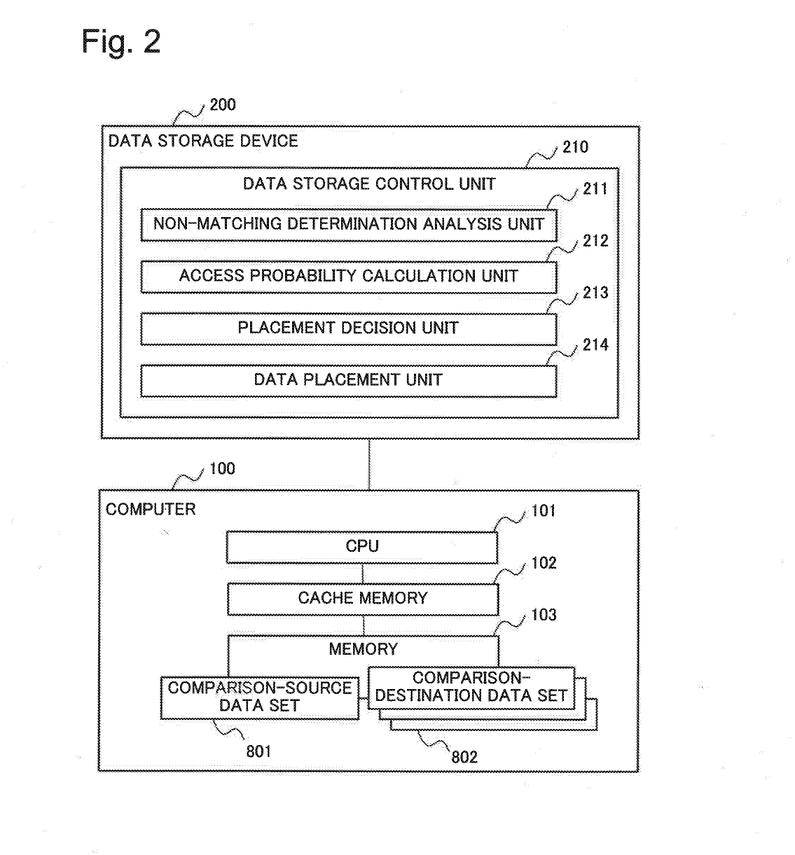

FIG. 2 is a block diagram illustrating a configuration of a pattern matching system according to the first exemplary embodiment of the present invention. Referring to FIG. 2, the pattern matching system includes a computer 100 that executes a pattern matching process in accordance with the matching program 900, and a data storage device 200 that stores comparison-destination data sets 802 in a memory 103 of the computer 100. The data storage device 200 is an exemplary embodiment of an information processing device according to the present invention.

The computer 100 includes a central process unit (CPU) 101, a cache memory 102, and the memory 103.

The CPU 101 executes the matching program 900.

The memory 103 memorizes a comparison-source data set 801 and comparison-destination data sets 802. In addition, the memory 103 stores the matching program 900.

The cache memory 102 stores data elements read out from the memory 103 when processing of the matching program 900 is executed on the CPU 101. The cache memory 102 simultaneously stores data elements which is sequentially stored in a predetermined range of the memory 103 from data elements read out by the CPU 101. When there is no more capacity in the cache memory 102 to further store data elements, old data elements are deleted to store new data elements. When there are data elements to be read out from the memory 103 in a cache, the CPU 101 reads out the data elements stored in the cache.

The data storage device 200 includes a data storage control unit 210. The data storage control unit 210 includes a non-matching determination analysis unit 211, an access probability calculation unit 212, a placement decision unit 213, and a data placement unit 214.

The non-matching determination analysis unit 211 analyzes order of non-matching determinations to be carried out by the respective non-matching determination processes 930-j in the matching program 900.

The access probability calculation unit 212 calculates access probabilities for respective data elements dj of the comparison-destination data set 802.

The placement decision unit 213 decides placement order of the comparison-destination data sets 802 on the memory 103, based on the access probabilities for the respective data elements calculated by the access probability calculation unit 212.

The data placement unit 214 places the comparison-destination data sets 802 on the memory 103 in accordance with the decided order.

Note that the data storage device 200 may be a computer that includes a CPU and a storage medium storing a program and that operates under control based on the program.

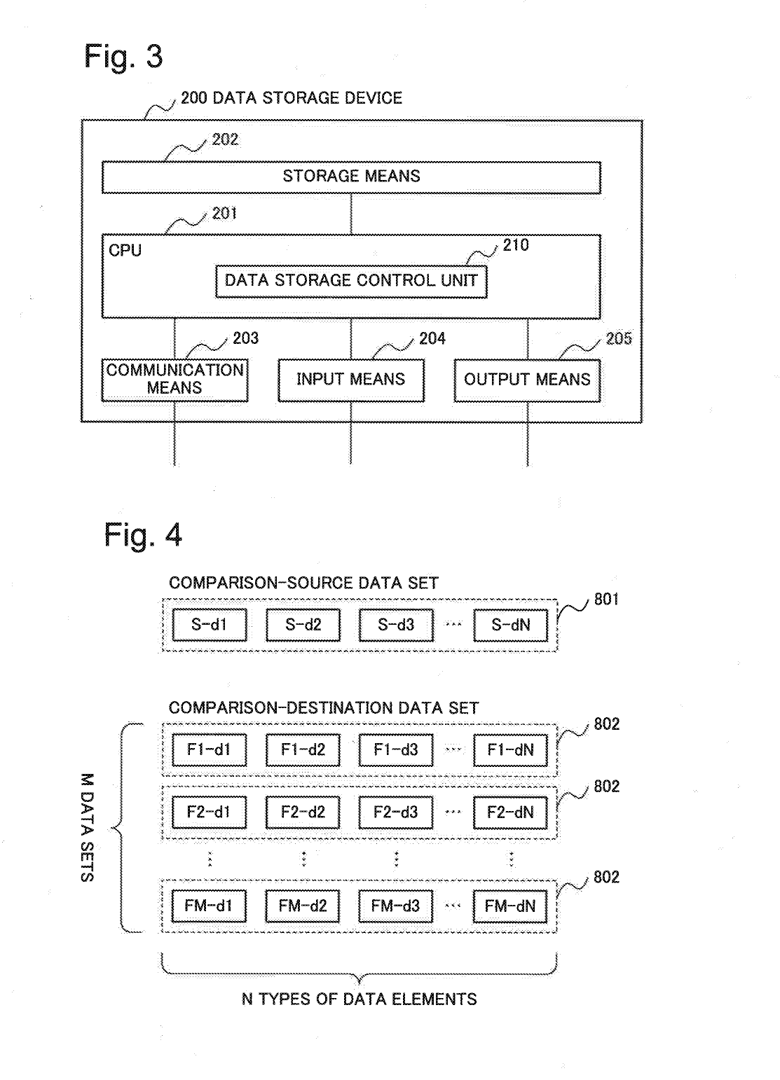

FIG. 3 is a block diagram illustrating a configuration of the data storage device 200 implemented by a computer according to the first exemplary embodiment of the present invention. The data storage device 200 includes a CPU 201, a storage means (storage medium) 202 such as a hard disk and a memory, a communication means 203 for performing data communication with other devices and the like, an input means 204 such as a keyboard, and an output means 205 such as a display.

The CPU 201 executes a computer program for achieving a function of the data storage control unit 210. The storage means 202 stores a computer program for achieving a function of the data storage control unit 210 and the matching program 900 acquired from the computer 100. The communication means 203 transmits an instruction for storing the comparison-destination data sets 802 to the computer 100. In addition, the communication means 203 may transmit and receive the matching program 900 to and from the computer 100. The input means 204 accepts an input of an instruction for data storage. The output means 205 outputs a result of data storage.

In addition, each of the components of the data storage device 200 illustrated in FIG. 2 may be an independent logic circuitry.

In addition, in the first exemplary embodiment of the present invention, the computer 100 and the data storage device 200 are separate devices. However, the data storage device 200 may be implemented on the computer 100.

Next, an operation according to the first exemplary embodiment of the present invention is described.

Herein, the operation is described by using an example in which the comparison-destination data sets 802 in FIG. 4 are stored in the memory 103 of the computer 100.

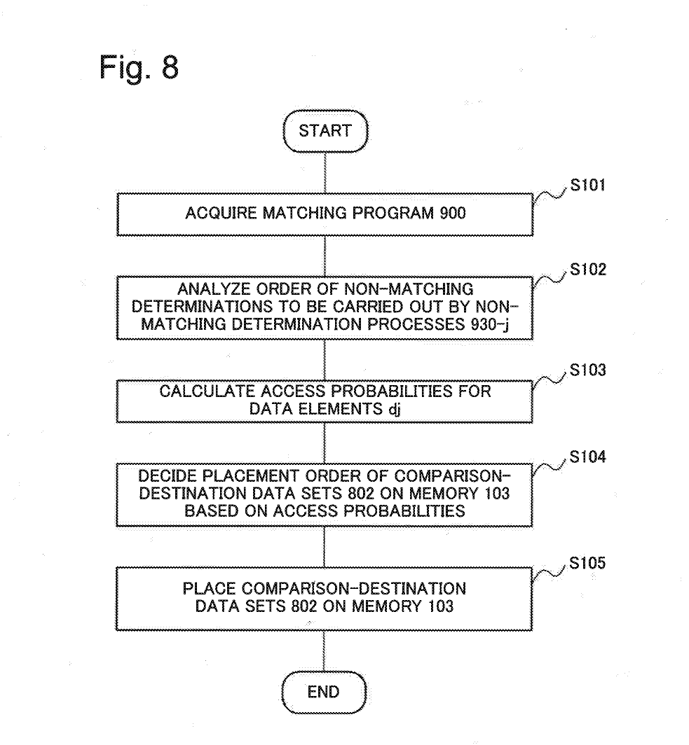

FIG. 8 is a flowchart illustrating processing of data storage according to the first exemplary embodiment of the present invention.

First, upon accepting an instruction for data storage from an administrator or the like, the data storage device 200 acquires the matching program 900 (Step S101).

For example, the data storage device 200 acquires the matching program 900 in FIG. 5 from the computer 100.

The non-matching determination analysis unit 211 analyzes order of non-matching determinations to be carried out by the respective non-matching determination processes 930-j in the matching program 900 (Step S102).

For example, the non-matching determination analysis unit 211 detects that non-matching determinations are carried out in order of the non-matching determination processes 930-1, 930-2, . . . , 930-N in the matching program 900 in FIG. 5.

The access probability calculation unit 212 calculates access probabilities for respective data elements dj of the comparison-destination data sets 802 (Step S103).

Herein, the access probability for the data element dj corresponds to a probability that the non-matching determination process 930-j carries out a non-matching determination (a probability of reaching a non-matching determination by the non-matching determination process 930-j). The probability that the non-matching determination process 930-j carries out a non-matching determination is calculated based on a probability that “non-matching” is determined (a non-matching probability) in each of non-matching determinations from a first type to a type immediately before. The non-matching probability for each of types is set in advance by, for example, an administrator or the like. In addition, the non-matching probability for each of the types may be acquired by the computer 100 at the time of execution of a pattern matching process. Note that an access probability for a type for which a non-matching determination is carried out first in each of the comparison-destination data sets 802 is “100%”.

For example, when a non-matching probability for data elements of respective types is “50%”, the access probability calculation unit 212 calculates access probabilities for data elements d1, d2, d3 . . . as “100%”, “50%”, “25%” . . . , respectively.

The placement decision unit 213 decides placement order of the comparison-destination data sets 802 on the memory 103, based on the access probabilities calculated by the access probability calculation unit 212 (Step S104).

Herein, for data elements of a type with an access probability of “100%”, the placement decision unit 213 decides placement order in an “inter-data set direction”. The “inter-data set direction” indicates that data elements of different comparison-destination data sets 802 are placed sequentially in order in which the data elements are processed in the matching program 900. In addition, for data elements of a type with an access probability of less than “100%”, the placement decision unit 213 decides placement order in an “intra-data set direction”. The “intra-data set direction” indicates that data elements of same comparison-destination data sets 802 are placed sequentially in order in which non-matching determinations are carried out.

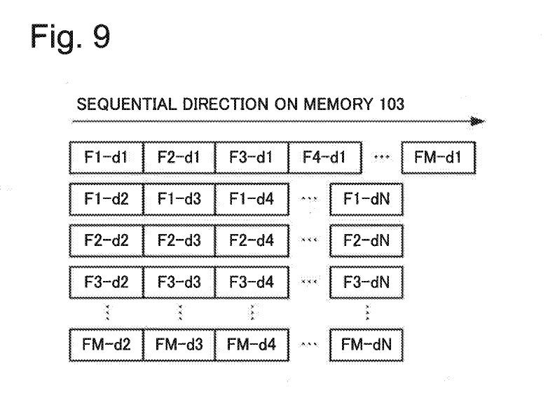

FIG. 9 is a diagram illustrating placement order of data elements on the memory 103 according to the first exemplary embodiment of the present invention. For example, for data elements d1 with an access probability of “100%”, the placement decision unit 213 decides placement order in order of “F1-d1”, “F2-d1”, . . . , “FM-d1” as illustrated in FIG. 9. In addition, for data elements d2, . . . , dN with an access probability of less than “100%”, the placement decision unit 213 decides placement order in order of “F1-d2”, “F1-d3”, . . . , “F1-dN”, “F2-d2”, “F2-d3”, . . . , “F2-dN”, . . . .

Note that when access probabilities of a plurality of types are “100%”, the placement decision unit 213 decides placement order of data elements of the respective types in the “inter-data set direction”. For example, when access probabilities of data elements d1 and d2 are “100%”, the placement decision unit 213 decides placement order of the data elements d1 and d2 in order of “F1-d1”, “F2-d1”, . . . , “FM-d1”, “F1-d2”, “F2-d2”, . . . , “FM-d2”.

The data placement unit 214 places the comparison-destination data sets 802 on the memory 103 of the computer 100 in accordance with the decided placement order (Step S105).

Herein, the data placement unit 214 may place the comparison-destination data sets 802 input by an administrator or the like on the memory 103 of the computer 100 in accordance with the decided placement order. In addition, the data placement unit 214 may rearrange the comparison-destination data sets 802 already stored on the memory 103 in accordance with the decided placement order.

For example, the data placement unit 214 places the comparison-destination data sets 802 in FIG. 4 on the memory 103 in accordance with the placement order in FIG. 9.

In this manner, in the first exemplary embodiment of the present invention, data elements of a type with an access probability of “100%” are placed in the “inter-data set direction”. Thus, a data element of a certain comparison-destination data set 802 and a data element of a comparison-destination data set 802 to be processed next are simultaneously stored in the cache memory 102. Further, the data element of the comparison-destination data set 802 to be processed next is read out from the cache memory 102. This reduces access from the CPU 101 to the memory 103.

In addition, data elements of a type with an access probability of less than “100%” are placed in the “intra-data set direction”. Thus, in a comparison-destination data set 802, a data element to be processed in a certain non-matching determination and a data element to be processed in a next non-matching determination are simultaneously stored in the cache memory 102. Further, the data element to be processed in the next non-matching determination is read out from the cache memory 102. This reduces access from the CPU 101 to the memory 103.

Finally, the data storage device 200 outputs a result of the data storage to an administrator or the like.

The operation according to the first exemplary embodiment of the present invention is thus completed.

Note that in the first exemplary embodiment of the present invention, the placement decision unit 213 decides placement order of data elements of a type with an access probability of “100%” in the “inter-data set direction”, and decides placement order of data elements of a type with an access probability of less than “100%” in the “intra-data set direction”. Without limitation to this, however, the placement decision unit 213 may decide placement order of data elements of a type with an access probability of equal to or more than a predetermined value in the “inter-data set direction”, and may decide placement order of data elements of a type with an access probability of less than a predetermined value in the “intra-data set direction”.

In addition, the placement decision unit 213 may decide placement order of data elements of types for which non-matching determinations are carried out, for example, from first order to order preset by an administrator or the like in the “inter-data set direction”, and may decide placement order of data elements of other types in the “intra-data set direction”.

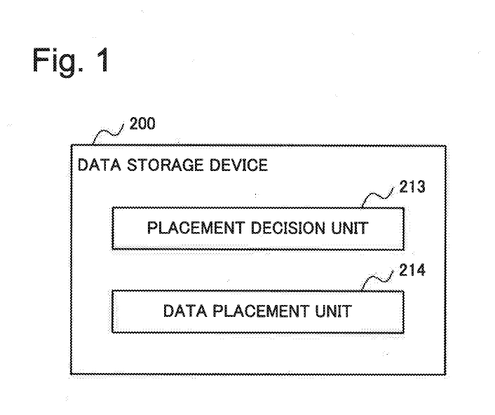

Next, a characteristic configuration of the first exemplary embodiment of the present invention will be described. FIG. 1 is a block diagram illustrating a characteristic configuration according to the first exemplary embodiment of the present invention.

A data storage device 200 (an information processing device) places a predetermined number of data sets on a memory of a computer. The data set includes a plurality of types of data elements. In the computer, a program for repeatedly carrying out a set of processes (a loop process) for the predetermined number of the data sets is executed. The set of processes includes carrying out a predetermined operation sequentially for respective types of data elements in the data set when a predetermined condition is satisfied.

The data storage device 200 includes a placement decision unit 213 and a data placement unit 214.

The placement decision unit 213 decides placement order on the memory in such a way that, for data elements of a specific type among data elements of the plurality of types, data elements of different data sets are placed sequentially in order in which the data elements are processed by the program and, for data elements of a type other than the specific type, data elements of a same data set are placed sequentially in order in which the data elements are processed by the program.

The data placement unit 214 places the predetermined number of the data sets on the memory of the computer in accordance with the placement order.

The first exemplary embodiment of the present invention enables execution of a pattern matching process between data sets each including a plurality of types of data elements at high speed. The reason is that the placement decision unit 213 decides placement order in the “inter-data set direction” for data elements of a specific type, and decides placement order in the “intra-data set direction” for data elements of a type other than the specific type.

Consequently, for example, data elements of a type with an access probability of “100%” are placed on the memory 103 in the “inter-data set direction”, and data elements of a type with an access probability of less than “100%” are placed on the memory 103 in the “intra-data set direction”. Further, since data elements to be processed sequentially by a program may be simultaneously stored in the cache memory 102 with high possibility, access to the memory 103 is reduced and the program can be executed at high speed.

### Second Exemplary Embodiment

Next, a second exemplary embodiment of the present invention is described. The second exemplary embodiment of the present invention is different from the first exemplary embodiment of the present invention in that a description of the matching program 900 is converted into a description corresponding to placement order.

First, a configuration according to the second exemplary embodiment of the present invention is described.

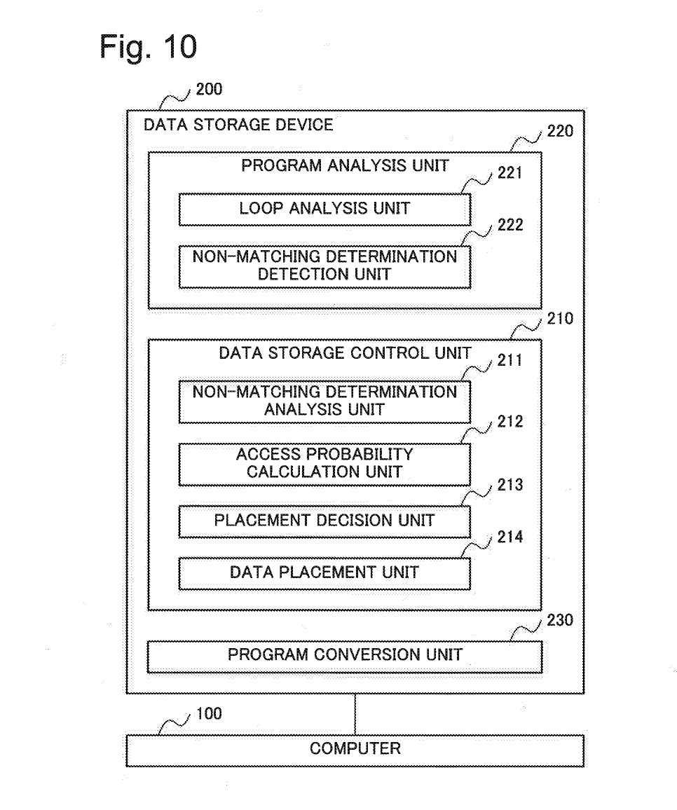

FIG. 10 is a block diagram illustrating a configuration of a pattern matching system according to the second exemplary embodiment of the present invention.

A data storage device 200 according to the second exemplary embodiment of the present invention includes, in addition to the configuration of the data storage device 200 according to the first exemplary embodiment of the present invention, a program analysis unit 220 and a program conversion unit 230. The program analysis unit 220 includes a loop analysis unit 221 and a non-matching determination detection unit 222.

The loop analysis unit 221 detects a loop in the matching program 900.

The non-matching determination detection unit 222 detects the non-matching determination processes 930-j in the detected loop.

The program conversion unit 230 converts a description of the matching program 900 into a description corresponding to the decided placement order.

Next, an operation according to the second exemplary embodiment of the present invention is described.

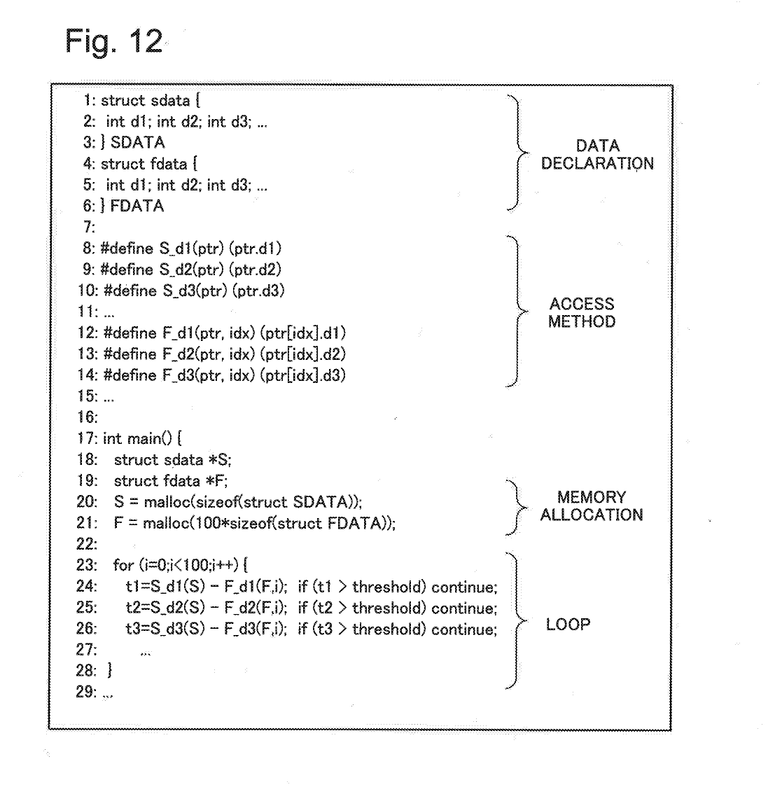

FIG. 12 is a diagram illustrating an example of a program code of the matching program 900 according to the second exemplary embodiment of the present invention. In the example in FIG. 12, the number of the comparison-destination data sets 802 is one hundred. Herein, the operation is described using the example in which a program code of the matching program 900 is as in FIG. 12.

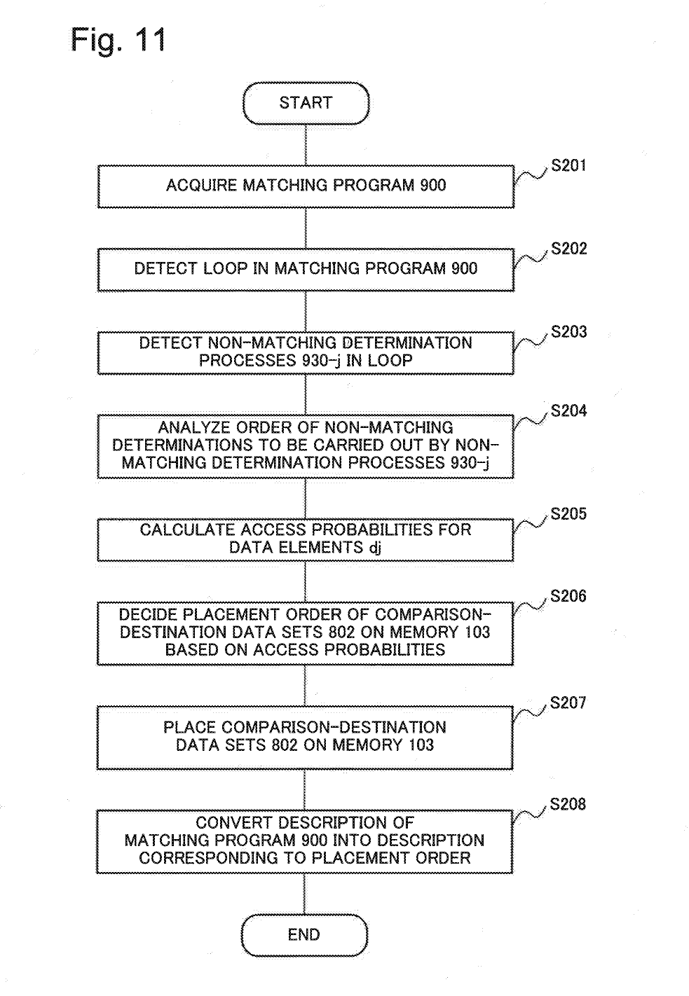

FIG. 11 is a flowchart illustrating processing of data storage according to the second exemplary embodiment of the present invention.

First, the data storage device 200 acquires the matching program 900 (Step S201).

For example, the data storage device 200 acquires the program code in FIG. 12 from the computer 100.

The loop analysis unit 221 detects a loop in the matching program 900 (Step S202). The non-matching determination detection unit 222 detects the non-matching determination processes 930-j in the detected loop (Step S203).

For example, the data storage device 200 detects a loop (line numbers 23 to 28) in the program code in FIG. 12 from the computer 100. The data storage device 200 then detects the non-matching determination processes 930-1 (line number 24), 930-2 (line number 25), 930-3 (line number 26), . . . in the loop.

The processing from analysis of order of non-matching determinations by the respective non-matching determination processes 930-j to placement of the comparison-destination data sets 802 in accordance with the decided placement order (Steps S204 to S207) is the same as the first exemplary embodiment (Steps S102 to S105) of the present invention.

For example, the non-matching determination analysis unit 211 detects that non-matching determinations are carried out in order of the non-matching determination processes 930-1, 930-2, 930-3, . . . in the program code in FIG. 12. The placement decision unit 213 then decides placement order as illustrated in FIG. 9.

Next, the program conversion unit 230 converts a description of the matching program 900 into a description corresponding to the decided placement order (Step S208). Herein, the program conversion unit 230 converts, for example, a description of the matching program 900 relating to a data declaration, a memory allocation, a data access method, and the like into a description corresponding to the placement order.

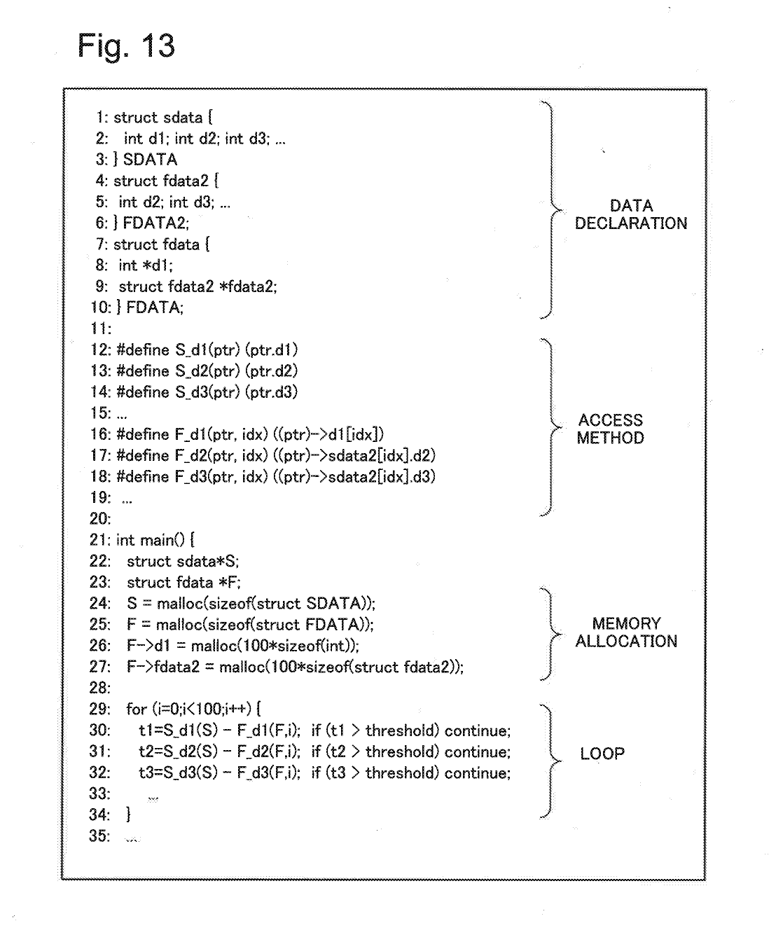

FIG. 13 is a diagram illustrating an example of a program code of the converted matching program 900 according to the second exemplary embodiment of the present invention.

For example, the program conversion unit 230 converts a data declaration (line numbers 1 to 6), a memory allocation (line numbers 20 and 21), and a data access method (line numbers 8 to 15) in the program code in FIG. 12 into a description as in FIG. 13.

The operation according to the second exemplary embodiment of the present invention is thus completed.

Note that when access probabilities for a plurality of types for which non-matching determinations are sequentially carried out are “100%”, non-matching is not determined in a non-matching determination to be carried out first. Thus, the first non-matching determination can be considered as an unnecessary determination. In this case, at Step S208 described above, the program conversion unit 230 may delete a non-matching determination process 930-j relating to the unnecessary non-matching determination from the matching program 900.

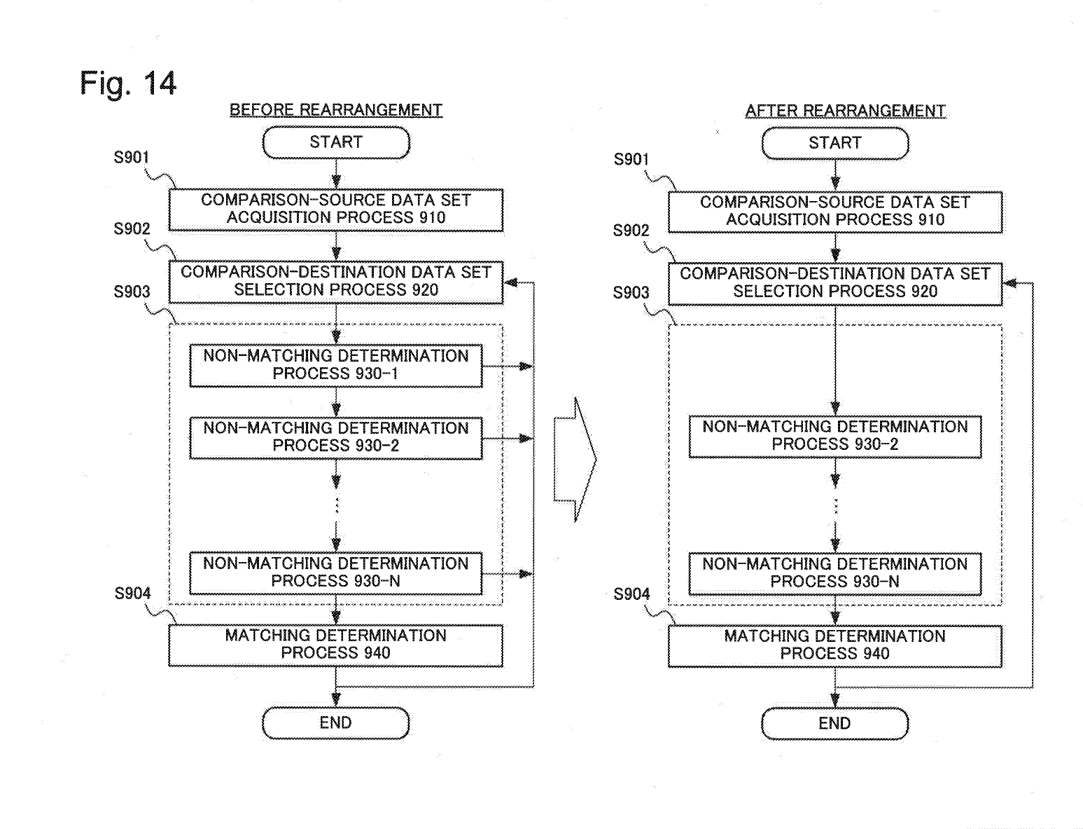

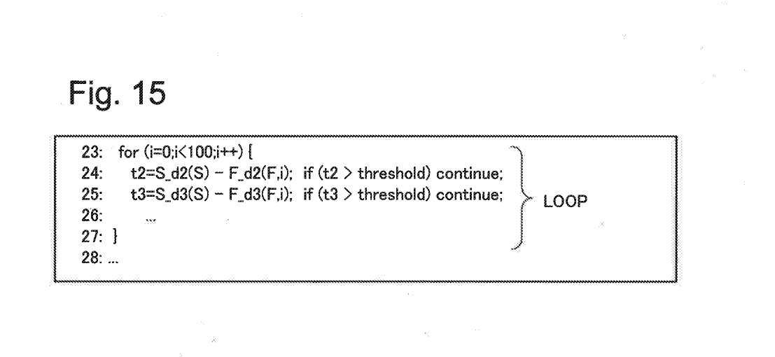

FIG. 14 is a diagram illustrating an example of conversion of the matching program 900 according to the second exemplary embodiment of the present invention. FIG. 15 is a diagram illustrating another example of a program code after the conversion of the matching program 900 according to the second exemplary embodiment of the present invention. In the example in FIG. 15, only a part corresponding to the loop is illustrated.

For example, when access probabilities of data elements d1 and d2 are “100%”, the program conversion unit 230 deletes the non-matching determination process 930-1 relating to a non-matching determination to be carried out first from the matching program 900, as in FIGS. 14 and 15.

The second exemplary embodiment of the present invention enables to convert a program for carrying out a pattern matching process into a program with reduced memory access. The reason is that the program conversion unit 230 converts a description of the matching program 900 into a description corresponding to the decided placement order.

### Third Exemplary Embodiment

Next, a third exemplary embodiment of the present invention is described. The third exemplary embodiment of the present invention is different from the second exemplary embodiment of the present invention in that execution order of the non-matching determination processes 930-j is rearranged.

First, a configuration according to the third exemplary embodiment of the present invention is described.

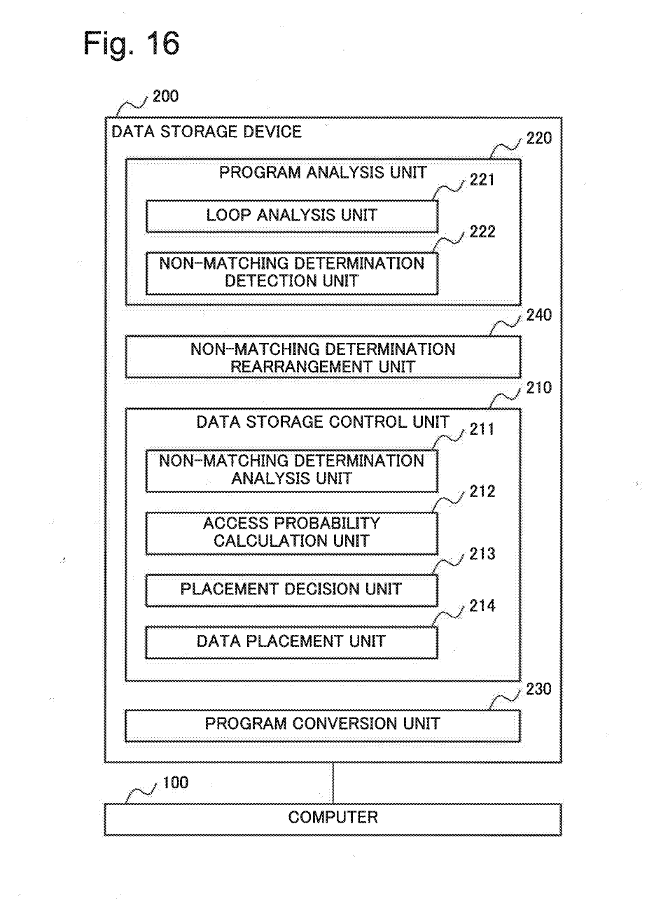

FIG. 16 is a block diagram illustrating a configuration of a pattern matching system according to the third exemplary embodiment of the present invention.

A data storage device 200 according to the third exemplary embodiment of the present invention includes, in addition to the configuration of the data storage device 200 according to the second exemplary embodiment of the present invention, a non-matching determination rearrangement unit (or rearrangement unit) 240.

The non-matching determination rearrangement unit 240 rearranges execution order of the non-matching determination processes 930-j in descending order of priority levels.

Next, an operation according to the third exemplary embodiment of the present invention is described.

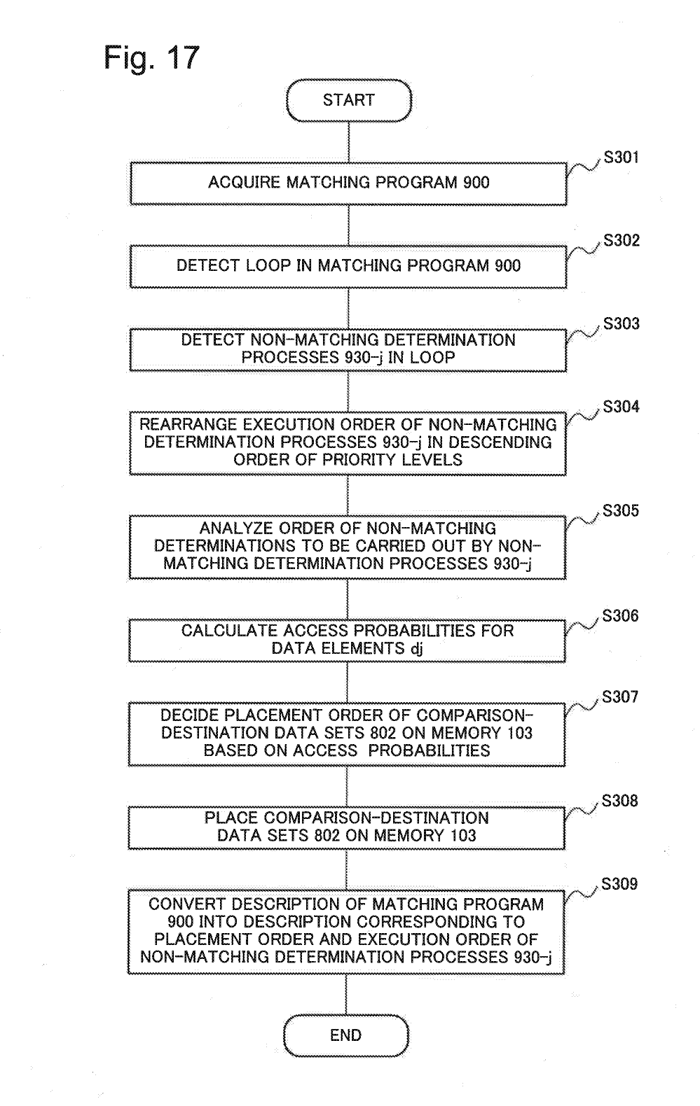

FIG. 17 is a flowchart illustrating processing of data storage according to the third exemplary embodiment of the present invention.

First, the processing from acquisition of the matching program 900 to detection of the non-matching determination processes 930-j (Steps S301 to S303) is the same as the second exemplary embodiment (Steps S201 to S203) of the present invention.

Next, the non-matching determination rearrangement unit 240 rearranges execution order of the non-matching determination processes 930-j in descending order of priority levels (Step S304).

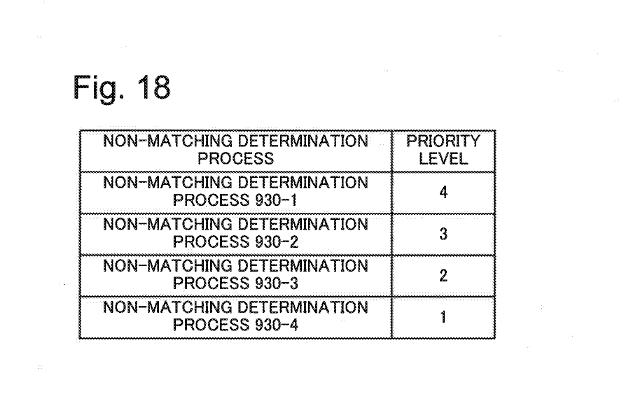

FIG. 18 is a diagram illustrating an example of priority levels for the non-matching determination processes 930-j according to the third exemplary embodiment of the present invention. In the example in FIG. 18, a smaller value of a priority level indicates a higher priority level.

A priority level is assigned based on, for example, a non-matching probability of data element dj of a type corresponding to each of the non-matching determination processes 930-j in such a way that a larger non-matching probability becomes higher in a priority level.

Note that a priority level may be assigned in such a way that each of the non-matching determination processes 930-j with a less number of instructions, such as a number of load instructions, becomes higher in a priority level.

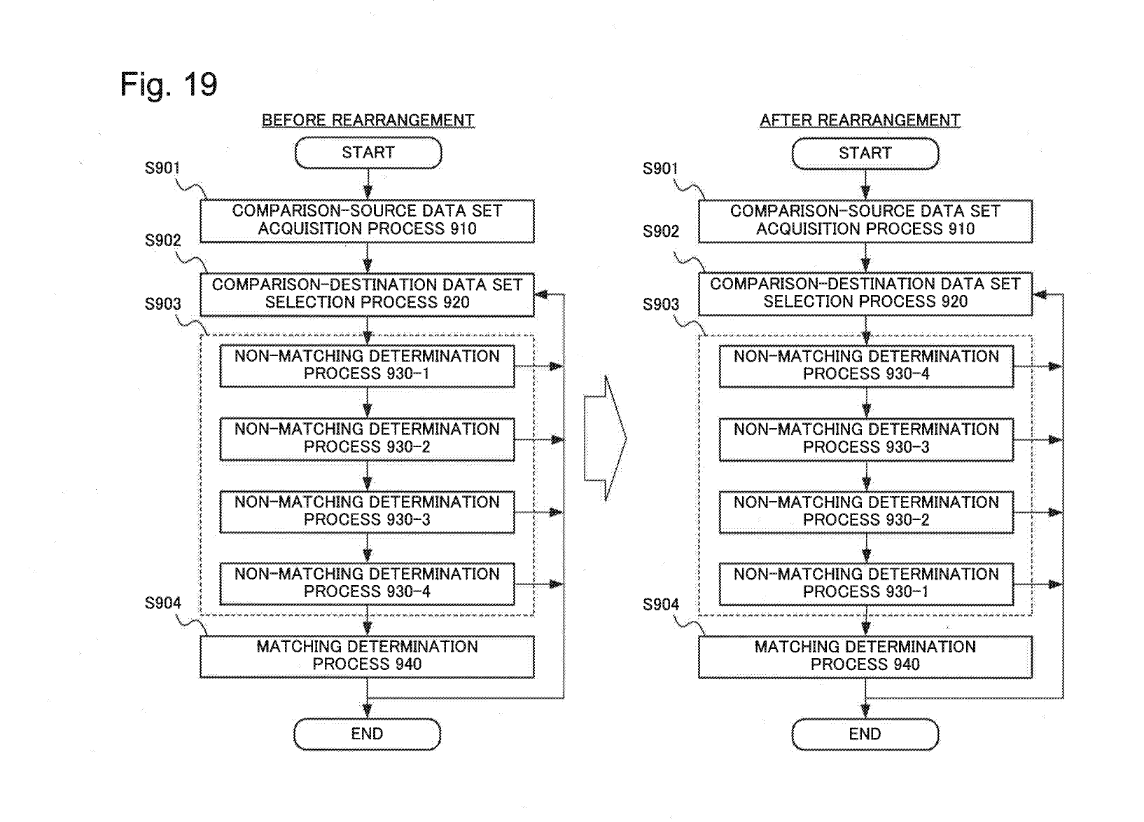

FIG. 19 is a diagram illustrating an example of rearrangement of the non-matching determination processes 930-j according to the third exemplary embodiment of the present invention.

For example, the non-matching determination rearrangement unit 240 rearranges, based on the priority levels in FIG. 18, execution order of the non-matching determination processes 930-j as in FIG. 19. In this case, non-matching determinations are carried out in order of the non-matching determination processes 930-1, 930-2, 930-3, 930-4 before the rearrangement. After the rearrangement, non-matching determinations are carried out in order of the non-matching determination processes 930-4, 930-3, 930-2, 930-1 in accordance with the priority levels in FIG. 18.

The processing from analysis of order of non-matching determinations by the respective non-matching determination processes 930-j to placement of the comparison-destination data sets 802 in accordance with the decided placement order (Steps S305 to S308) is the same as the second exemplary embodiment (Steps S204 to S207) of the present invention.

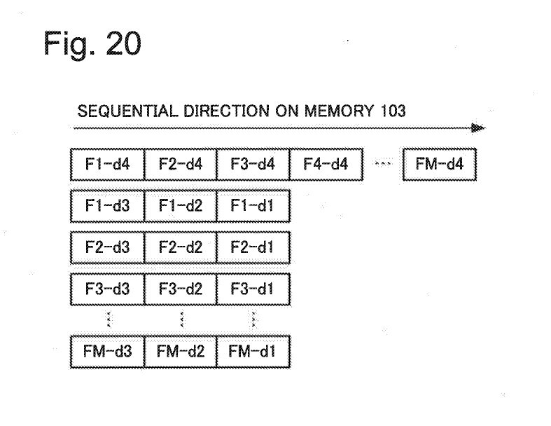

FIG. 20 is a diagram illustrating placement order of data elements on the memory 103 according to the third exemplary embodiment of the present invention. For example, for data elements d4 with an access probability of “100%”, the placement decision unit 213 decides placement order in order of “F1-d4”, “F2-d4”, . . . , “FM-d4” as illustrated in FIG. 20. In addition, for data elements d1, d2, d3 with an access probability of less than “100%”, the placement decision unit 213 decides placement order as illustrated in FIG. 20, in accordance with execution order of non-matching determinations by the non-matching determination processes 930-j after the rearrangement. In other words, the placement decision unit 213 decides placement order in order of “F1-d3”, “F1-d2”, “F1-d1”, . . . , “FM-d3”, “FM-d2”, “FM-d1”.

Next, the program conversion unit 230 converts a description of the matching program 900 into a description corresponding to the decided placement order and the execution order of the non-matching determination processes 930-j after the rearrangement (Step S309).

The operation according to the third exemplary embodiment of the present invention is thus completed.

The third exemplary embodiment of the present invention enables to execute a pattern matching process at higher speed than the first and second exemplary embodiments of the present invention. The reason is that the non-matching determination rearrangement unit 240 rearranges execution order of the non-matching determination processes 930-j in the matching program 900 in descending order of priority levels.

Consequently, for example, by executing the non-matching determination processes 930-j in descending order of a non-matching probability, the number of times of executing the latter non-matching determination processes 930-j is reduced. In this case, since the number of load instructions involved in the non-matching determination processes 930-j is reduced, the matching program 900 can be executed at higher speed. In addition, for example, by executing the non-matching determination processes 930-j in ascending order of the number of load instructions, the number of times of executing the non-matching determination processes 930-j with a large number of load instructions is reduced. In this case, since the number of load instructions involved in the non-matching determination processes 930-j is reduced, the matching program 900 can be executed at higher speed.

### Fourth Exemplary Embodiment

Next, a fourth exemplary embodiment of the present invention is described. The fourth exemplary embodiment of the present invention is different from the second exemplary embodiment of the present invention in that a loop in the matching program 900 is split and vectorized.

First, a configuration according to the fourth exemplary embodiment of the present invention is described.

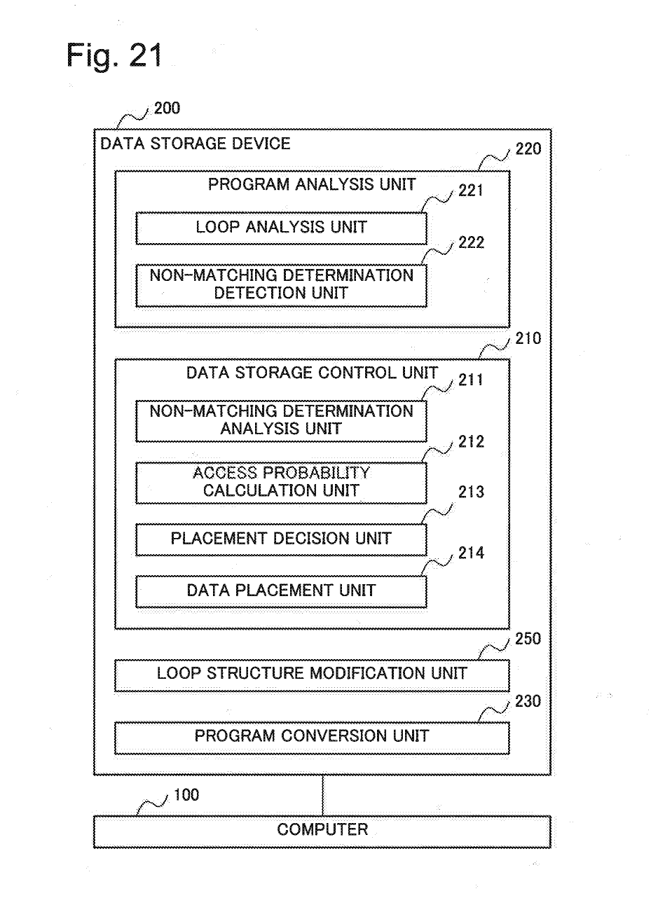

FIG. 21 is a block diagram illustrating a configuration of a pattern matching system according to the fourth exemplary embodiment of the present invention.

A data storage device 200 according to the fourth exemplary embodiment of the present invention includes, in addition to the configuration of the data storage device 200 according to the second exemplary embodiment of the present invention, a loop structure modification unit (or structure modification unit) 250.

The loop structure modification unit 250 splits a loop in the matching program 900.

Next, an operation according to the fourth exemplary embodiment of the present invention is described.

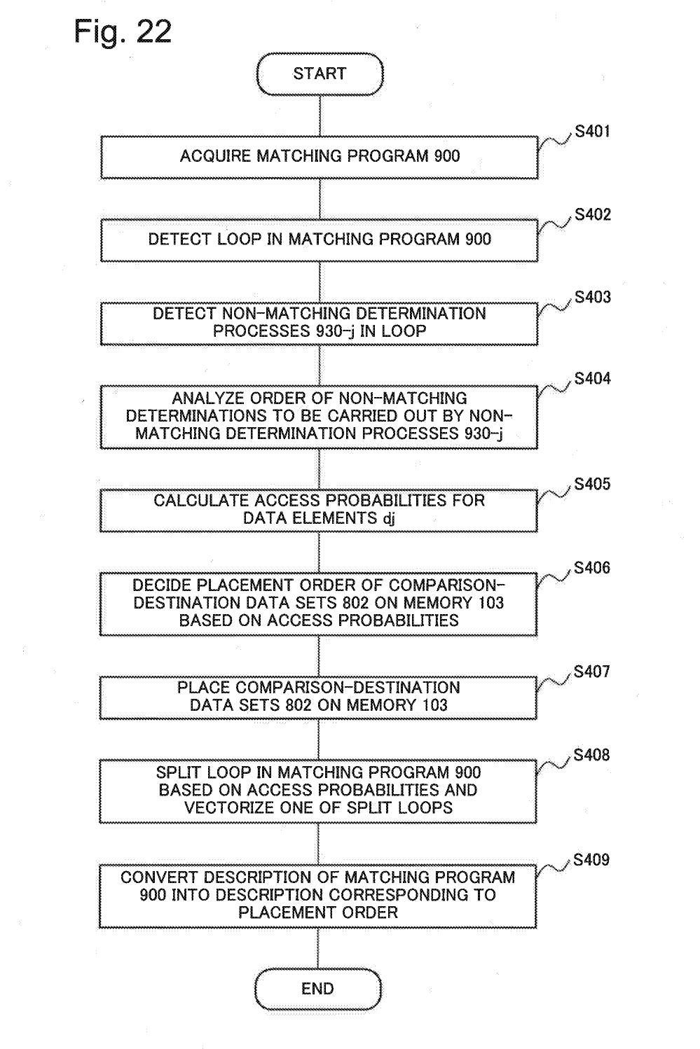

FIG. 22 is a flowchart illustrating processing of data storage according to the fourth exemplary embodiment of the present invention.

First, the processing from acquisition of the matching program 900 to placement of the comparison-destination data sets 802 in accordance with the decided placement order (Steps S401 to S407) is the same as the second exemplary embodiment (Steps S201 to S207) of the present invention.

Next, the loop structure modification unit 250 splits the loop in the matching program 900, based on the access probabilities for respective data elements calculated by the access probability calculation unit 212. The loop structure modification unit 250 then vectorizes one of the split loops (Step S408). Herein, the loop structure modification unit 250 splits the loop into a loop 1 and a loop 2 by extracting, from the non-matching determination process 930-j for a type with an access probability of “100%”, a process (operation) involving no determination as being a separate loop (loop 1). The loop structure modification unit 250 then vectorizes the loop 1 (specifies the loop 1 so as to be processed by a vector operation for a plurality of the comparison-destination data sets 802).

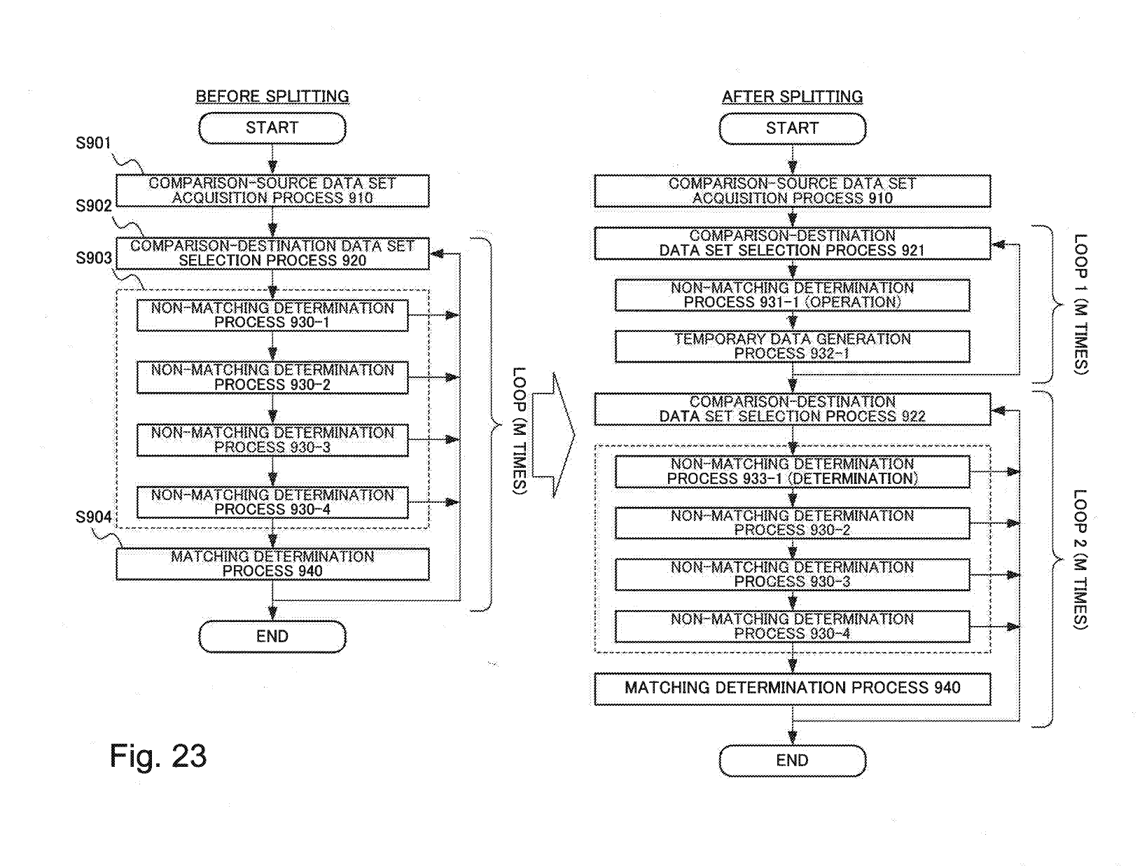

FIG. 23 is a diagram illustrating an example of loop splitting according to the fourth exemplary embodiment of the present invention.

For example, the loop structure modification unit 250 splits the loop in the matching program 900 in FIG. 7 into a loop 1 and a loop 2, as illustrated in FIG. 23.

The loop 1 includes a comparison-destination data set selection process 921, a non-matching determination process 931-1, and a temporary data generation process 932-1. The comparison-destination data set selection process 921 selects a comparison-destination data set 802, in the same way as the comparison-destination data set selection process 920. The non-matching determination process 931-1 carries out a process (operation) involving no determination in the non-matching determination process 930-1. The temporary data generation process 932-1 generates a result of the operation of the non-matching determination process 931-1 as a temporary data element. The loop 1 generates temporary data elements of the number of the comparison-destination data sets 802.

The loop 2 includes a comparison-destination data set selection process 922, a non-matching determination process 933-1, and the non-matching determination process 930-2 through the matching determination process 940. The comparison-destination data set selection process 922 selects a comparison-destination data set 802, in the same way as the comparison-destination data set selection process 920. The non-matching determination process 933-1 carries out a processing relating to determination in the non-matching determination process 930-1 by using the temporary data element.

The loop structure modification unit 250 then vectorizes the loop 1.

The program conversion unit 230 converts a description of the matching program 900 into a description corresponding to the decided placement order, in the same way as Step S208 (Step S409).

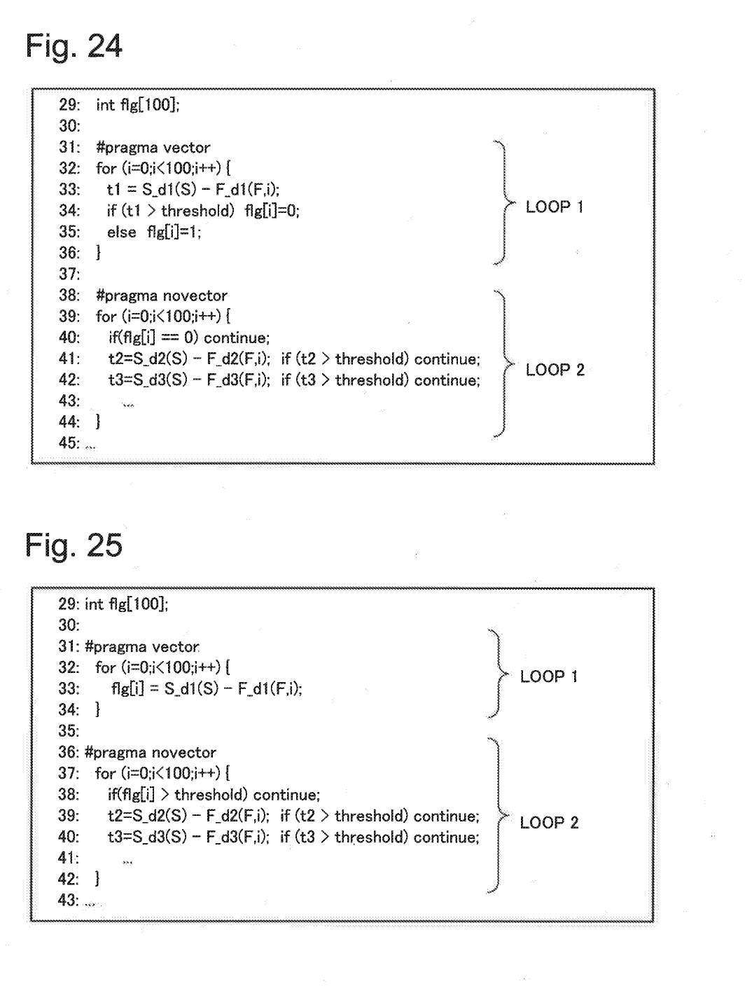

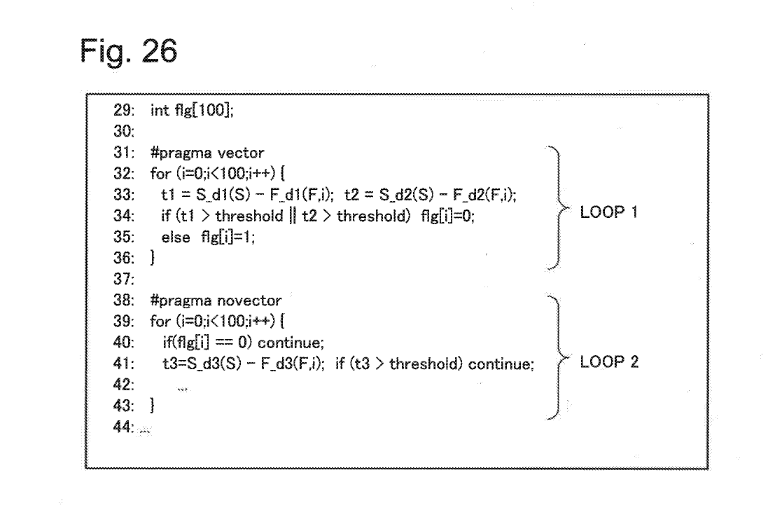

FIGS. 24 and 25 are diagrams each illustrating an example of a program code of the matching program 900 after the conversion according to the fourth exemplary embodiment of the present invention. In each of the examples in FIGS. 24 and 25, only a part corresponding to the loop is illustrated.

For example, the loop structure modification unit 250 splits the loop in the program code in FIG. 12 into a loop 1 and a loop 2 as in FIG. 24 or 25.

FIG. 24 is an example in which the non-matching determination process 931-1 carries out calculation of a difference and comparison with a threshold value included in the non-matching determination process 930-1. In this case, a result of the comparison with a threshold value is generated as a temporary data element (line numbers 34 and 35). In addition, FIG. 25 is an example in which the non-matching determination process 931-1 carries out calculation of a difference included in the non-matching determination process 930-1. In this case, a result of the calculation of a difference is generated as a temporary data element (line number 33). In addition, in each of FIGS. 24 and 25, vectorization of the loop 1 by a compiler is specified by “#pragma vector” (line number 31).

Note that when there are a plurality of types having an access probability of “100%”, the loop structure modification unit 250 extracts, from the non-matching determination processes 930-j for the plurality of types, processes (operations) involving no determination as a separate loop (loop 1).

FIG. 26 is a diagram illustrating another example of a program code of the matching program 900 after the conversion according to the fourth exemplary embodiment of the present invention. For example, the loop structure modification unit 250 extracts, from the processes by the non-matching determination processes 930-1 and 930-2, calculation of a difference and comparison with a threshold value as one separate loop (loop 1), and vectorizes the loop, as in FIG. 26.

The operation according to the fourth exemplary embodiment of the present invention is thus completed.

The fourth exemplary embodiment of the present invention enables to execute a pattern matching process at higher speed than the first and second exemplary embodiments. The reason is that the loop structure modification unit 250 splits the non-matching determination process 930-j of a specific type in a loop in the matching program 900, and vectorizes the loop so as to be processed by a vector operation for a plurality of the comparison-destination data sets 802.

Consequently, load instructions for the number of repetition of a loop (the number of the comparison-destination data sets 802) relating to the non-matching determination process 930-j for data elements of a specific type can be changed into a vector load instruction that is less in number than that of the repetition, and the number of load instructions is reduced. The reduction in the number of load instructions shortens a time required for data loading, and the matching program 900 can be executed at higher speed.

### Fifth Exemplary Embodiment

Next, a fifth exemplary embodiment of the present invention is described. The fifth exemplary embodiment of the present invention is different from the fourth exemplary embodiment of the present invention in that a new loop including two split loops is generated.

At Step S408 described above, the loop structure modification unit 250 splits the loop in the matching program 900, and sets the number of repetition times of the two split loops to be less than the number of the comparison-destination data sets 802. The loop structure modification unit 250 further generates a new loop including the repetitions of the two split loops in such a way that the two split loops are executed by the number of the comparison-destination data sets 802.

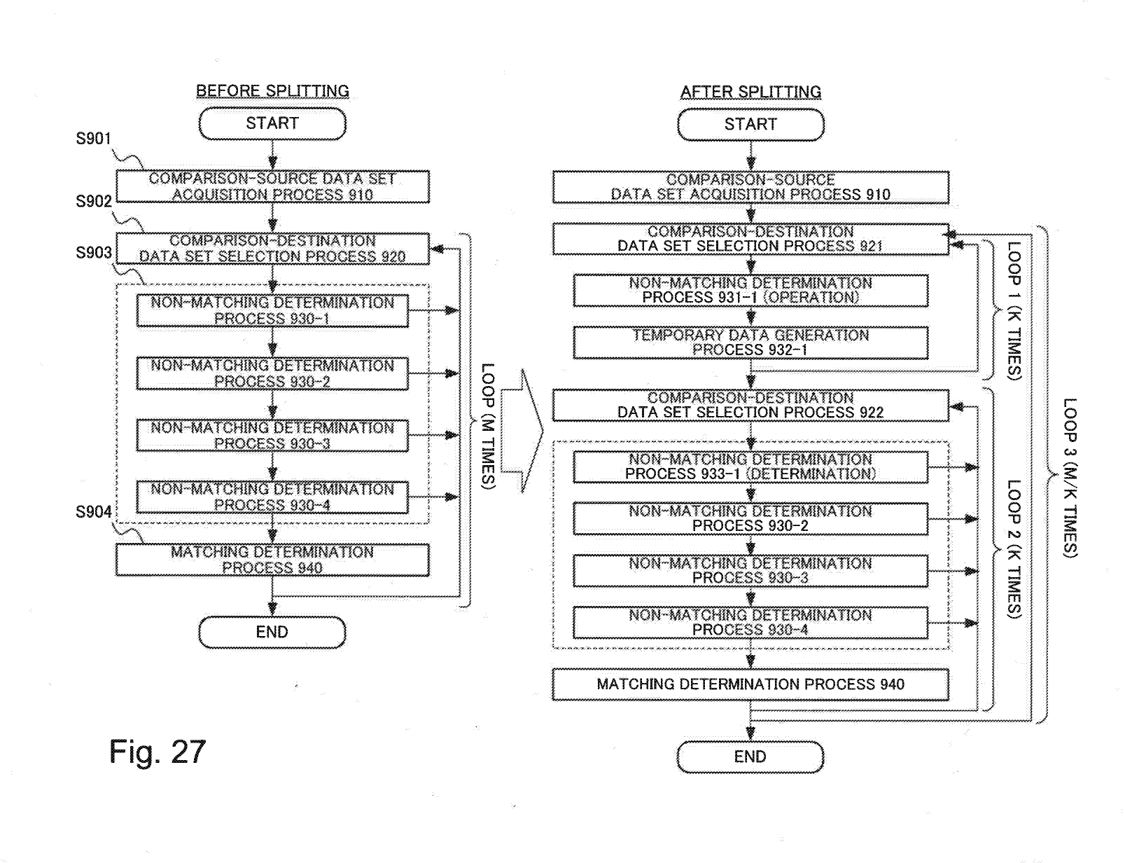

FIG. 27 is a diagram illustrating an example of loop splitting according to the fifth exemplary embodiment of the present invention.

For example, the loop structure modification unit 250 splits the loop in the matching program 900 into a loop 1 and a loop 2 with a number of repetition times of K (where K is an integer equal to or more than 1), as illustrated in FIG. 27. Herein, the number of repetition times K is a value less than the number of the comparison-destination data sets 802, and is set in such a way that a size of temporary data elements to be generated by K-time repetition of the loop 1 becomes smaller than a size of the cache memory 102.

The loop structure modification unit 250 further generates a loop 3 with a number of repetition times of M/K including the K-time loop 1 and the K-time loop 2, as illustrated in FIG. 27.

The loop structure modification unit 250 then vectorizes the loop 1.

The fifth exemplary embodiment of the present invention enables to execute a pattern matching process at higher speed than the fourth exemplary embodiment of the present invention. The reason is that the number of repetition times of two split loops is set to be less than the number of the comparison-destination data sets 802. Consequently, a temporary data element between the two loops exists in the cache memory 102, which shortens a time required for loading a temporary data element in the loop 2, and the matching program 900 can be executed at higher speed.

### Sixth Exemplary Embodiment

Next, a sixth exemplary embodiment of the present invention is described. The sixth exemplary embodiment of the present invention is different from the second exemplary embodiment in that execution order of the non-matching determination processes 930-j is rearranged in the same way as the third exemplary embodiment, and in that a loop in the matching program 900 is split in the same way as the fourth and fifth exemplary embodiments.

First, a configuration according to the sixth exemplary embodiment of the present invention is described.

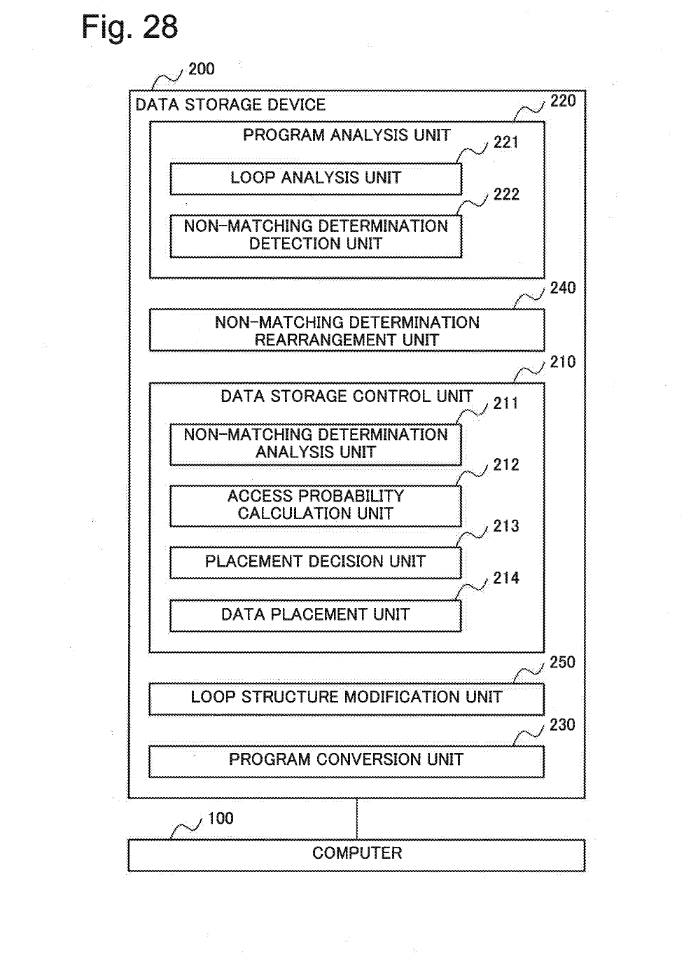

FIG. 28 is a block diagram illustrating a configuration of a pattern matching system according to the sixth exemplary embodiment of the present invention.

A data storage device 200 according to the fourth exemplary embodiment of the present invention includes, in addition to the configuration of the data storage device 200 according to the second exemplary embodiment of the present invention, a non-matching determination rearrangement unit 240 and a loop structure modification unit 250.

Next, an operation according to the sixth exemplary embodiment of the present invention is described.

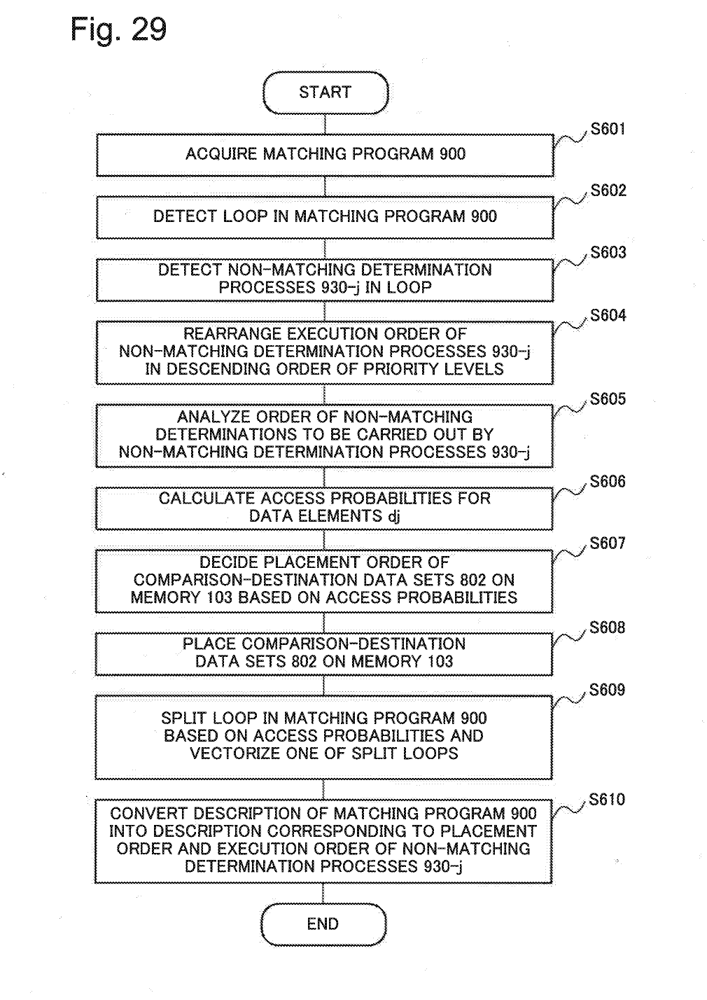

FIG. 29 is a flowchart illustrating processing of data storage according to the sixth exemplary embodiment of the present invention.

First, the processing from acquisition of the matching program 900 to detection of the non-matching determination processes 930-j (Steps S601 to S603) is the same as the second exemplary embodiment (Steps S201 to S203) of the present invention.

Next, the non-matching determination rearrangement unit 240 rearranges execution order of the non-matching determination processes 930-j in descending order of priority levels, in the same way as Step S304 (Step S604).

The processing from analysis of order of non-matching determinations by the respective non-matching determination processes 930-j to placement of the comparison-destination data sets 802 in accordance with the decided placement order (Steps S605 to S608) is the same as the second exemplary embodiment (Steps S204 to S207) of the present invention.

Next, the loop structure modification unit 250 splits the loop in the matching program 900, based on the access probabilities for respective data elements calculated by the access probability calculation unit 212, in the same way as Step S408. The loop structure modification unit 250 then vectorizes one of the split loops (Step S609).

The program conversion unit 230 converts a description of the matching program 900 into a description corresponding to the decided placement order and the execution order of the non-matching determination processes 930-j after rearrangement, in the same way as Step S309 (Step S610).

The operation according to the sixth exemplary embodiment of the present invention is thus completed.

The sixth exemplary embodiment of the present invention enables to execute a pattern matching process at higher speed than the third, fourth, and fifth exemplary embodiments of the present invention. The reason is that the non-matching determination rearrangement unit 240 rearranges execution order of the non-matching determination processes 930-j in the matching program 900 in descending order of priority levels, and the loop structure modification unit 250 splits and vectorizes the loop.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, in the exemplary embodiments of the present invention, description is given by using an example in which a program that uses data sets to be placed is the matching program 900 for carrying out pattern matching. However, the program may be another program other than pattern matching as long as it is a program for repeatedly carrying out a set of processes for a predetermined number of data sets, the set of processes including carrying out a predetermined operation sequentially for respective types in the data set when a predetermined condition is satisfied.

This application is based upon and claims the benefit of priority from Japanese Patent Application No. 2014-125865, filed on Jun. 19, 2014, the disclosure of which is incorporated herein in its entirety by reference.

### INDUSTRIAL APPLICABILITY

The present invention is applicable for use in image recognition processing and image matching processing for discriminating an image by comparison with a database, biometric authentication processing for identifying an individual by comparison with a database, and the like.

### REFERENCE SIGNS LIST

100 Computer
101 CPU
102 Cache memory
103 Memory
200 Data storage device
201 CPU
202 Storage means
203 Communication means
204 Input means
205 Output means
210 Data storage control unit
211 Non-matching determination analysis unit
212 Access probability calculation unit
213 Placement decision unit
214 Data placement unit
220 Program analysis unit
221 Loop analysis unit
222 Non-matching determination detection unit
230 Program conversion unit
240 Non-matching determination rearrangement unit
250 Loop structure modification unit
801 Comparison-source data set
802 Comparison-destination data set
900 Matching program
910 Comparison-source data set acquisition process
920 Comparison-destination data set selection process
921 Comparison-destination data set selection process
922 Comparison-destination data set selection process
930 Non-matching determination process
931 Non-matching determination process
932 Temporary data generation process
933 Non-matching determination process
940 Matching determination process

What is claimed is:

1. An information processing device for placing a predetermined number of data sets each including a plurality of types of data elements on a memory of a computer in which a program for repeatedly carrying out a set of processes for the predetermined number of the data sets is executed, the set of processes including carrying out a predetermined operation sequentially for respective types of data elements in the data set when a predetermined condition is satisfied, the information processing device comprising:
a placement decision unit that decides placement order on the memory in such a way that, for data elements of a specific type among data elements of the plurality of types, data elements of different data sets are placed sequentially in order in which the data elements are processed by the program and, for data elements of a type other than the specific type, data elements of a same data set are placed sequentially in order in which the data elements are processed by the program; and
a data placement unit that places the predetermined number of the data sets on the memory of the computer in accordance with the placement order.

2. The information processing device according to claim 1, wherein
the specific type is a type for which a probability that the predetermined operation is carried out by the program is equal to or more than a predetermined value, among the plurality of types.

3. The information processing device according to claim 1, further comprising
a program conversion unit that rewrites, in accordance with the placement order, a description relating to the predetermined number of the data sets in the program into a description corresponding to the placement order.

4. The information processing device according to claim 1, further comprising:
a rearrangement unit that rearranges order of types in which the predetermined operation is carried out in the program, in accordance with respective priority levels for the plurality of types.

5. The information processing device according to claim 1, further comprising
a structure modification unit that modifies the program in such a way that the predetermined operation for the specific type of data elements is split from the set of processes and is carried out by a vector operation for a plurality of the data sets.

6. An data storage method for placing a predetermined number of data sets each including a plurality of types of data elements on a memory of a computer in which a program for repeatedly carrying out a set of processes for the predetermined number of the data sets is executed, the set of processes including carrying out a predetermined operation sequentially for respective types of data elements in the data set when a predetermined condition is satisfied, the information processing device comprising:
deciding placement order on the memory in such a way that, for data elements of a specific type among data elements of the plurality of types, data elements of different data sets are placed sequentially in order in which the data elements are processed by the program and, for data elements of a type other than the specific type, data elements of a same data set are placed sequentially in order in which the data elements are processed by the program; and
placing the predetermined number of the data sets on the memory of the computer in accordance with the placement order.

7. The data storage method according to claim 6, wherein
the specific type is a type for which a probability that the predetermined operation is carried out by the program is equal to or more than a predetermined value, among the plurality of types.

8. The data storage method according to claim 6, further comprising
rewriting, in accordance with the placement order, a description relating to the predetermined number of the data sets in the program into a description corresponding to the placement order.

9. The data storage method according to claim 6, further comprising:
rearranging order of types in which the predetermined operation is carried out in the program, in accordance with respective priority levels for the plurality of types.

10. A non-transitory computer readable storage medium recording thereon a program for an information processing device for placing a predetermined number of data sets each including a plurality of types of data elements on a memory of a computer in which a predetermined program for repeatedly carrying out a set of processes for the predetermined number of the data sets is executed, the set of processes including carrying out a predetermined operation sequentially for respective types of data elements in the data set when a predetermined condition is satisfied, the program causing the information processing device to perform a method comprising:
deciding placement order on the memory in such a way that, for data elements of a specific type among data elements of the plurality of types, data elements of different data sets are placed sequentially in order in which the data elements are processed by the predetermined program and, for data elements of a type other than the specific type, data elements of a same data set are placed sequentially in order in which the data elements are processed by the predetermined program; and
placing the predetermined number of the data sets on the memory of the computer in accordance with the placement order.
